(19) United States
(12) Patent Application Publication
(10) Pub. No.: US 2010/0026840 A1
(43) Pub. Date: Feb. 4, 2010

(54) SYSTEM AND METHOD FOR DISPLAYING AN ELECTRONIC CALENDAR FOR BROWSING IMAGES ASSOCIATED WITH A SCHEDULED EVENT IN A MOBILE ELECTRONIC DEVICE

(75) Inventors: SHU-HAN YU, Tu-Cheng (TW); SHENG-CHIEN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/489,452

(22) Filed: Jun. 23, 2009

(30) Foreign Application Priority Data
Jul. 31, 2008 (CN) 200810303274.2

(51) Int. Cl. H04N 5/76; G06K 9/60

(52) U.S. Cl. 348/231.2; 348/E05.031; 382/305

(57) ABSTRACT

A system and method for displaying an electronic calendar for browsing images associated with a scheduled event in a mobile electronic device captures one or more images by a camera and stores the captured images into a cache. The system and method further obtains information of the captured images from the cache, and associates the captured images with a file directory where the scheduled event is stored. Furthermore, the system and method saves the captured images from the cache into the file directory, and highlights the date of the captured images in the electronic calendar to indicate that there are images captured on the highlighted date.

### BACKGROUND

1. Technical Field

Embodiments of the present disclosure are related to electronic device management systems and methods, and particularly to a system and method for displaying an electronic calendar for browsing images associated with a scheduled event in a mobile electronic device.

2. Description of Related Art

A mobile electronic device usually includes a small visual display for output, and a small keyboard or touch screen for input. Currently, some mobile electronic devices utilize a camera for additional function. However, if a user wants to view an image and further wants to know on which day the image was captured, the mobile electronic device has to invoke an image album interface. Then the user searches for the image in the image album interface and gets the date of the image by viewing information of the image. It is very inconvenient for the user to operate and much time will be wasted.

Therefore, there is a need for a system and method to overcome the aforementioned problem.

### BRIEF DESCRIPTION OF THE DRAWINGS

FIG. 1 is a block diagram of one embodiment of a mobile electronic device 1 comprising a system for displaying an electronic calendar for browsing images associated with a scheduled event.

FIG. 2 is a flowchart of one embodiment of a method for displaying the electronic calendar for browsing images associated with the scheduled event in the mobile electronic device.

FIG. 3 illustrates one embodiment of the electronic calendar without any highlights.

FIG. 4 illustrates one embodiment of the highlighted electronic calendar.

### DETAILED DESCRIPTION

All of the processes described below may be embodied in, and fully automated via, function modules executed by one or more general purpose processors of a mobile electronic device. Some or all of the methods may alternatively be embodied in specialized hardware. The function modules may be stored in any type of computer-readable medium or other computer storage device.

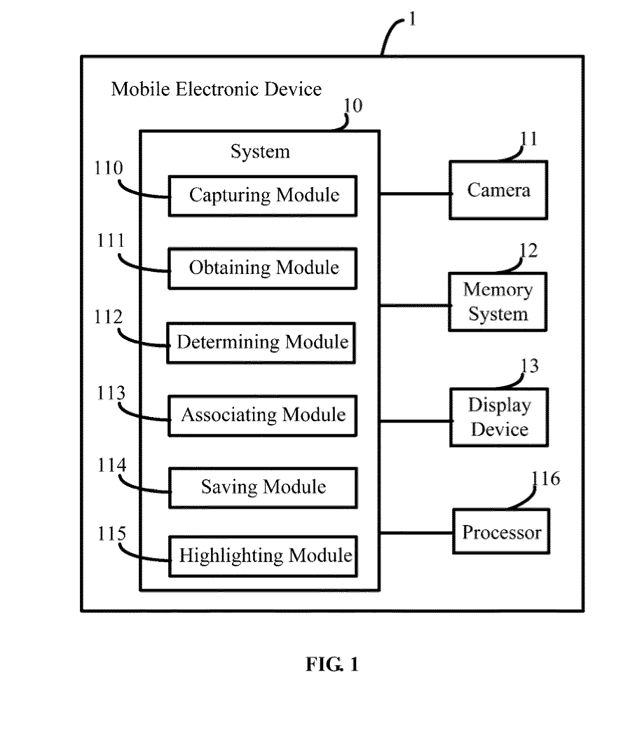

FIG. 1 is a block diagram of one embodiment of a mobile electronic device 1 comprising a system 10. The system 10 may be used to display an electronic calendar for browsing images associated with a scheduled event. In one embodiment, the mobile electronic device 1 includes a camera 11, a memory system 12, and a display device 13. The camera 11 captures images of objects, such as a person.

The memory system 12 includes a file directory structure that is configured with one or more file directories. Each file directory stores one or more images captured on one day, and may also store a scheduled event predetermined by a user of the mobile electronic device 1. The memory system 12 may be an internal memory system card or an external memory system card, such as a smart media card (SMC), a secure digital card (SDC), a compact flash card (CFC), a multi media card (MMC), a memory system stick (MS), an extreme digital card (XDC), a trans flash card (TFC), a random access memory (RAM), or a read only memory (ROM). Depending on the embodiment, the mobile electronic device 1 may be a mobile phone, a personal digital assistant (PDA), a handheld game player, a digital camera, or any other portable electronic device with an image capturing function.

In one embodiment, the system 10 includes a capturing module 110, an obtaining module 111, a determining module 112, an associating module 113, a saving module 114, and a highlighting module 115. One or more computerized codes of the modules 110-115 are stored in the memory system 12. One or more general purpose or specialized processors, such as a processor 116 executes the computerized codes of the modules 110-115 to provide one or more operations of the mobile electronic device 1.

The capturing module 110 is operable to capture one or more images by the camera 11 of the mobile electronic device 1 and store the captured images into a cache of the memory system 12. In one embodiment, the cache of the memory system 12 may reside in the random access memory (RAM) of the memory system 12, or the read only memory (ROM) of the memory system 12, for example.

The obtaining module 111 is operable to obtain information of the captured images from the cache of the memory system 12. In one embodiment, the information of the captured images includes a name of each of the captured images, a date of the captured images, for example. The information of the captured images may comprise metadata from the captured images.

The determining module 112 is operable to determine if the date of the captured images matches a scheduled date of the scheduled event of the electronic calendar of the mobile electronic device 1. In one embodiment, the scheduled event further includes a type, a subject, a start time, an end time, and a detailed description of the scheduled event.

The associating module 113 is operable to associate the captured images with a file directory of the memory system 12 where the scheduled event is stored, in response to a determination that the date of the captured images matches the scheduled date of the scheduled event. In one embodiment, for example, if the name of a captured image is “001,” and the file directory is “A,” then the associating module 113 associates the name of the captured image “001” with the file directory “A.”

The saving module 114 is operable to save the captured images from the cache into the file directory where the scheduled event is stored. In one embodiment, the saving module 114 saves the captured images from the cache into the file directory “A.”

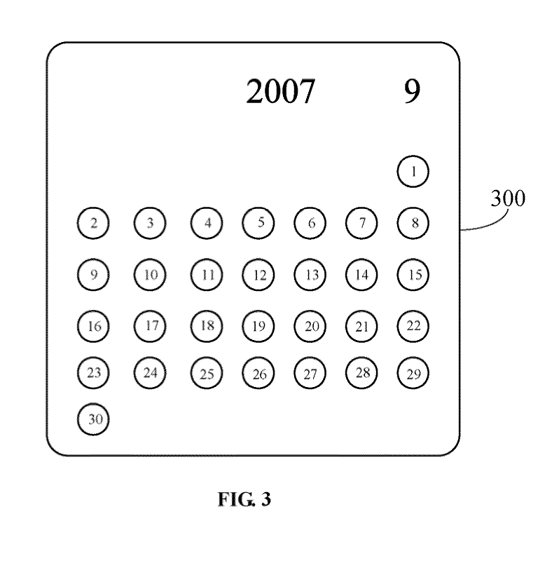

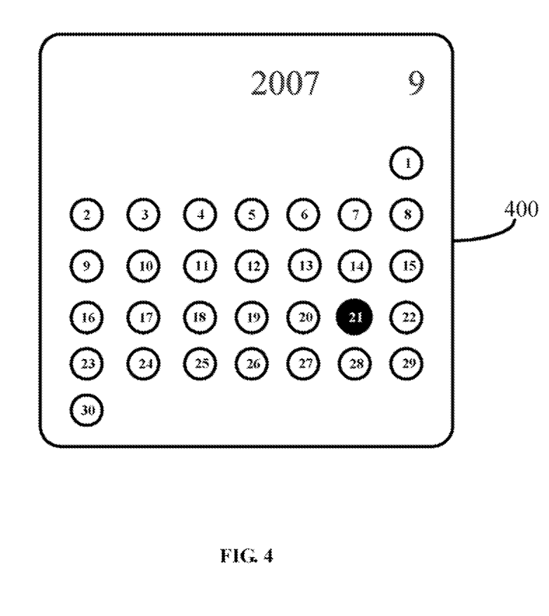

The highlighting module 115 is operable to highlight the date of the captured images in the electronic calendar 400 to indicate that there are images captured on the highlighted date. In one embodiment, the date of the captured images can be highlighted by changing a background color of the date of the captured images in the electronic calendar 400 or by changing a color of the figure of the date of the captured images in the electronic calendar 400. In one embodiment, as shown in FIG. 3, there is an electronic calendar 300 without any highlights. Each date is shown in a circle. For example, as shown in FIG. 4, the highlighting module 115 highlights the date of Sept. 21 by changing the background color in the electronic calendar 400. The electronic calendar 400 indicates that there are images captured on the highlighted date of Sept. 21, if the color of the date of Sept. 21 has been changed.

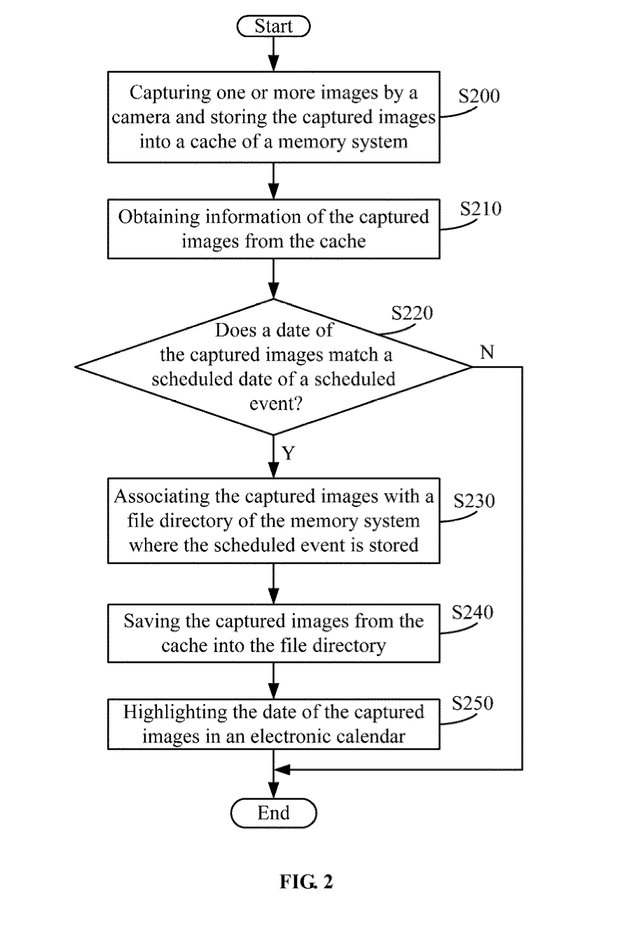

FIG. 2 is a flowchart of one embodiment of a method for displaying an electronic calendar for browsing images associated with a scheduled event in a mobile electronic device 1. Depending on the embodiment, additional blocks may be added, while others deleted, and the blocks may also be executed in a different order than described.

In block S200, the capturing module 110 captures one or more images by a camera 11 of the mobile electronic device 1 and stores the captured images into a cache of the memory system 12.

In block S210, the obtaining module 111 is operable to obtain information of the captured images from the cache of the memory system 12. As mentioned above, the information of the captured images includes a name of each of the captured images, a date of the captured images, for example. The information of the captured images may comprise metadata from the captured images.

In block S220, the determining module 112 determine if the date of the captured images matches a scheduled date of the scheduled event of the electronic calendar of the mobile electronic device. As mentioned above, the scheduled event further includes a type, a subject, a start time, an end time, and a detailed description of the scheduled event. In one embodiment, if the date of the captured images is September 21, and the scheduled date of the scheduled event is September 22, then the procedure ends. Otherwise, if the date of the captured images and the scheduled date of the scheduled event are September 21, the procedure goes to block S230.

In block S230, the associating module 113 associates the captured images with a file directory where the scheduled event is stored, in response to a determination that the date of the captured images matches the scheduled date of the scheduled event. In one embodiment, for example, if the name of a captured image is “001,” and the file directory is “A,” then the associating module 113 associates the name of the captured image “001” with the file directory “A.”

In block S240, the saving module 114 saves the captured images from the cache into the file directory where the scheduled event is stored. As mentioned above, if the cache stores a captured image “001,” then the saving module 114 saves the captured images “001” into the file directory “A.”

In block S250, the highlighting module 115 highlights the date of the captured images in the electronic calendar 400 to indicate that there are images captured on the highlighted date. As mentioned above, the date of the captured images can be highlighted by changing a background color of the date of the captured images in the electronic calendar 400 or by changing a color of the figure of the date of the captured images in the electronic calendar 400. In one embodiment, as shown in FIG. 3, there is an electronic calendar 300 without any highlights. Each date is shown in a circle. For example, as shown in FIG. 4, the highlighting module 115 highlights the date of September 21 by changing the background color in the electronic calendar 400. The electronic calendar 400 indicates that there are images captured on the highlighted date of Sept. 21 in the electronic calendar 400, if the color of the date of Sept. 21 has been changed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile electronic device comprising a memory system storing a plurality of programs and a processor that executes one or more operations for the plurality of programs, the programs comprising:
a capturing module operable to capture one or more images by a camera of the mobile electronic device and store the captured images into a cache of the memory system;
an obtaining module operable to obtain information of the captured images from the cache, the information of the captured images comprising a date of the captured images;
a determining module operable to determine if the date of the captured images matches a scheduled date of a scheduled event of an electronic calendar of the mobile electronic device;
an associating module operable to associate the captured images with a file directory of the memory system where the scheduled event is stored, in response to a determination that the date of the captured images matches the scheduled date of the scheduled event;
a saving module operable to save the captured images from the cache into the file directory where the scheduled event is stored; and
a highlighting module operable to highlight the date of the captured images in the electronic calendar to indicate that there are images captured on the highlighted date.

2. The computing system of claim 1, wherein the information of the captured images comprises a name of each of the captured images.

3. The computing system of claim 1, wherein the scheduled event comprises a type, a subject, a start time, an end time, and a detailed description of the scheduled event.

4. The computing system of claim 1, wherein the mobile electronic device is selected from the group consisting of a mobile phone, a personal digital assistant (PDA), a handheld game player, and a digital camera.

5. The computing system of claim 1, wherein the memory system is selected from the group consisting of a smart media card (SMC), a secure digital card (SDC), a compact flash card (CFC), a multi media card (MMC), a memory system stick (MS), an extreme digital card (XDC), a trans flash card (TFC), a random access memory (RAM), and a read only memory (ROM).

6. A method for displaying an electronic calendar for browsing images associated with a scheduled event in a mobile electronic device, the method comprising:
capturing one or more images by a camera of the mobile electronic device and storing the captured images into a cache of the memory system;
obtaining information of the captured images from the cache, the information of the captured images comprising a date of the captured images;
determining if a date of the captured images matches a scheduled date of the scheduled event of the electronic calendar of the mobile electronic device;
associating the captured images with a file directory where the scheduled event is stored, in response to a determination that the date of the captured images matches the scheduled date of the scheduled event;
saving the captured images into the file directory of the memory system where the scheduled event is stored; and
highlighting the date of the captured images in the electronic calendar to indicate that there are images captured on the highlighted date.

7. The method of claim 6, wherein the information of the captured images comprises a name of each of the captured images.

8. The method of claim 6, wherein the scheduled event comprises a type, a subject, a start time, an end time, and a detailed description of the scheduled event.

9. The method of claim 6, wherein the mobile electronic device is selected from the group consisting of a mobile phone, a personal digital assistant (PDA), a handheld game player, and a digital camera.

10. The method of claim 6, wherein the memory system is selected from the group consisting of a smart media card (SMC), a secure digital card (SDC), a compact flash card (CFC), a multi media card (MMC), a memory system stick (MS), an extreme digital card (XDC), a trans flash card (TFC), a random access memory (RAM), and a read only memory (ROM).

11. A storage medium having stored thereon instructions that, when executed by a mobile electronic device, causes the mobile electronic device to perform a method for displaying an electronic calendar for browsing images associated with a scheduled event, the method comprising:
capturing one or more images by a camera of the mobile electronic device and storing the captured images into a cache of the memory system;
obtaining information of the captured images from the cache, the information of the captured images comprising a date of the captured images;
determining if a date of the captured images matches a scheduled date of the scheduled event of the electronic calendar of the mobile electronic device;
associating the captured images with a file directory where the scheduled event is stored, in response to a determination that the date of the captured images matches the scheduled date of the scheduled event;
saving the captured images into the file directory of the memory system where the scheduled event is stored; and
highlighting the date of the captured images in the electronic calendar to indicate that there are images captured on the highlighted date.

12. The medium of claim 11, wherein the information of the captured images comprises a name of each of the captured images.

13. The medium of claim 11, wherein the scheduled event comprises a type, a subject, a start time, an end time, and a detailed description of the scheduled event.

14. The medium of claim 11, wherein the mobile electronic device is selected from the group consisting of a mobile phone, a personal digital assistant (PDA), a handheld game player, and a digital camera.

15. The medium of claim 11, wherein the memory system is selected from the group consisting of a smart media card (SMC), a secure digital card (SDC), a compact flash card (CFC), a multi media card (MMC), a memory system stick (MS), an extreme digital card (XDC), a trans flash card (TFC), a random access memory (RAM), and a read only memory (ROM).
